(19) United States
(12) Patent Application Publication
(10) Pub. No.: US 2025/0248348 A1
(43) Pub. Date: Aug. 7, 2025

(54) PREPARATION METHOD FOR SEEDLING SUBSTRATE USING RESIDUES FROM POPULUS FORESTS AS RAW MATERIALS AND APPLICATION

(71) Applicant: Resarch Institute of Forestry Chinese Academy of Forestry, Beijing (CN)

(72) Inventors: Changjun DING, Beijing (CN); Chao NING, Beijing (CN); Weixi ZHANG, Beijing (CN); Xiaohua SU, Beijing (CN); Junlong LIU, Hefei (CN); Yufeng DONG, Jinan (CN)

(21) Appl. No.: 18/648,435

(22) Filed: Apr. 28, 2024

(30) Foreign Application Priority Data
Feb. 4, 2024 (CN) 202410157609.3

(51) Int. Cl. A01G 24/23; A01G 24/15; C05F 3/00; C05F 11/08; C05F 17/60

(52) U.S. Cl. CPC A01G 24/23; A01G 24/15; C05F 3/00; C05F 11/08; C05F 17/60

(57) ABSTRACT

The present disclosure provides a preparation method for a seedling substrate using residues from Populus forests as raw materials and an application. The preparation method for a seedling substrate includes the following steps: crushing Populus fallen leaves into Populus fallen leaf scraps; crushing Populus dead branches into Populus dead branch scraps; mixing the Populus fallen leaf scraps, the Populus dead branch scraps, chicken manures and garden soil to obtain a mixture; adding effective microorganisms (EM) bacterial powder to the mixture for fermentation; and adding perlite during the fermentation to obtain a seedling substrate. The seedling substrate provided in the present disclosure is rich in microorganisms and comprehensive in nutrients, does not require additional fertilizers in a seedling stage, and is capable of promoting the growth of forest seedlings.

### CROSS-REFERENCE TO RELATED APPLICATIONS

This application claims priority of Chinese Patent Application No. 202410157609. 3, filed on Feb. 4, 2024, the entire contents of which are incorporated herein by reference.

### TECHNICAL FIELD

The present disclosure relates to agricultural seedling cultivation, and specifically to a preparation method for a seedling substrate using residues from Populus forests as raw materials and an application.

### BACKGROUND

In modern forest seedling production, the large-scale, containerization and lightweight of seedling production have become prevailing trends, and a seedling substrate is an important prerequisite for large-scale production of forest seedlings. Raw materials for a conventional light-weight seedling substrate are mostly peat, vermiculite, perlite, etc., of which the peat is recognized as the best raw material for seedling substrate, and accordingly, peat consumption in seedling industry is increasing rapidly. However, the peat is a mineral resource which is non-renewable in a short period of time, and large-scale exploitation of peat will seriously damage the wetland resources that are regarded as the kidney of the earth.

Populus is widely used in construction, furniture, plywood, paper and man-made fiber manufacturing, which can bring immeasurable economic, ecological and social benefits for social development. The main composition of agricultural and forestry residues is lignocellulosic biomass mainly composed of cellulose, hemicellulose and lignin. The agricultural and forestry residues from Populus forests are extremely large in amount and widely distributed, but they are decomposed slowly under natural conditions, which is prone to pests and diseases, and there are potential safety hazards in fire prevention when too much residues accumulate. In the prior art, the agricultural and forestry residues from Populus forests are naturally decomposed without rational utilization. As the scientific research moves forwards, the technical equipment level of forest seedling industry has been greatly improved, and the conventional seedling cultivation in field is not adequate for the needs of large-scale production of forest trees. In view of this, there is a need for the present disclosure to provide a method for rationally utilizing agricultural and forestry residues from Populus forests.

### SUMMARY

The present disclosure overcomes the shortcomings that residues from Populus forests fail to be utilized rationally in the large-scale production of seedlings in the prior art, and provides a seedling substrate using residues from Populus forests as raw materials and a preparation method and application thereof, getting rid of the excessive dependence on peat of a forest seedling substrate, and at the same time, making full use of agricultural and forestry residue resources by turning waste into treasures to promote the recycling of biomass resources.

In order to achieve the above objective, the present disclosure adopts the following technical solutions.

In a first aspect of the present disclosure, a preparation method for a seedling substrate using residues from Populus forests as raw materials is provided, including the following steps:
crushing Populus fallen leaves and Populus dead branches into Populus fallen leaf scraps and Populus dead branch scraps, respectively; and
mixing the Populus fallen leaf scraps, the Populus dead branch scraps, chicken manures and garden soil to obtain a mixture; adding effective microorganisms (EM) bacterial powder to the mixture for fermentation; and adding perlite during the fermentation to obtain a seedling substrate.

Preferably, the Populus fallen leaf scraps, the Populus dead branch scraps, the chicken manures, the garden soil and the perlite are mixed in volume percentages of 40%-60%, 10%-30%, 5%-15%, 5%-15%, and 5%-10% in a total of 100%,
the Populus fallen leaf scraps and the Populus dead branch scraps having a particle size of 5-8 mm.

Preferably, a mass of the EM bacterial powder is 0.05-0.1% of a mass of the mixture.

Preferably, the fermentation is large-heap fermentation or strip-stack fermentation.

Preferably, heap-turning and stack-transferring are performed every 5-7 days during the fermentation.

Preferably, the fermentation is performed at 60-65° C. for 40-50 days.

Preferably, a water content of the seedling substrate is 25-30%.

Preferably, the seedling substrate is further mixed with controlled-release fertilizers, 1 m³ of the seedling substrate being mixed with 1-3 kg of the controlled-release fertilizers.

In a second aspect of the present disclosure, a seedling substrate prepared by the preparation method is provided.

In a third aspect of the present disclosure, an application of the seedling substrate in forest seedling cultivation is provided.

Preferably, the seedling substrate is used for cultivating Quercus mongolica, Gleditsia sinensis, and Euonymus maackii.

The beneficial effects of the present disclosure are as follows. In the present disclosure, the residues from Populus forests are used to prepare the seedling substrate, making full use of agricultural and forestry residue resources by turning waste into treasures to promote the recycling of biomass resources, and at the same time, getting rid of the excessive dependence on peat of the forest seedling substrate.

(1) The fermentation and decomposition of fallen leaves and dead branches under natural conditions is a long-term process, and the addition of chicken manures to crushed fallen leaves and dead branches adjusts a carbon-nitrogen ratio of a mixed substrate; the addition of EM bacteria improves the fermentation efficiency; the addition of perlite in the process of heap-turning increases the porosity of the mixed substrate and is conducive to full fermentation; the addition of garden soil can increase the buffer of the substrate to fertilizers to facilitate the management of the seedling stage; the controlled-release fertilizers can release fertilizer efficiency for a longer period of time; and the mixed substrate after fermentation is more favorable to the growth of seedlings. Seedlings cultivated using the seedling substrate of the present disclosure are superior in survival rate, growth and the development degree of root system.

(2) The dead branches and fallen leaves are widely sourced and belong to agricultural and forestry residues, which, being left in forests for a long period of time, will increase the risk of disease and pests to the forest trees, and there are potential fire hazards when too many dead branches and fallen leaves accumulate in forests. The utilization of Populus dead branches and fallen leaves to process seedling substrate not only reduces the cost of production of seedling substrate, but also effectively eliminates the above disaster and risk.

(3) The seedling substrate using residues from Populus forests as raw materials is easy to prepare and operate, which is suitable for application and popularization in production.

### BRIEF DESCRIPTION OF THE DRAWINGS

FIG. 1A shows the growth of Quercus mongolica cultivated using a substrate 1;

FIG. 1B shows the growth of Quercus mongolica cultivated using a substrate 2;

FIG. 1C shows the growth of Quercus mongolica cultivated using a substrate 3;

FIG. 1D shows the growth of Quercus mongolica cultivated using a substrate 4;

FIG. 1E shows the growth of Quercus mongolica cultivated using a substrate 5; and

FIG. 1F shows the growth of Quercus mongolica cultivated using control substrates.

FIG. 2A shows the growth of Gleditsia sinensis cultivated using the substrate 1;

FIG. 2B shows the growth of Gleditsia sinensis cultivated using the substrate 2;

FIG. 2C shows the growth of Gleditsia sinensis cultivated using the substrate 3;

FIG. 2D shows the growth of Gleditsia sinensis cultivated using the substrate 4;

FIG. 2E shows the growth of Gleditsia sinensis cultivated using the substrate 5; and

FIG. 2F shows the growth of Gleditsia sinensis cultivated using the control substrates.

FIG. 3A shows the growth of Euonymus maackii cultivated using the substrate 1;

FIG. 3B shows the growth of Euonymus maackii cultivated using the substrate 2;

FIG. 3C shows the growth of Euonymus maackii cultivated using the substrate 3;

FIG. 3D shows the growth of Euonymus maackii cultivated using the substrate 4;

FIG. 3E shows the growth of Euonymus maackii cultivated using the substrate 5; and

FIG. 3F shows the growth of Euonymus maackii cultivated using the control substrates.

### DETAILED DESCRIPTION

The present disclosure is described in detail by reference to the accompanying drawings and specific examples below, which are not understood as limitations of the present disclosure. The technical means used in the examples mentioned below are conventional unless otherwise specified. The materials, reagents, etc. used in the examples mentioned below are available commercially unless otherwise specified.

EM bacterial powder is purchased from Kaijie Agriculture Co., Ltd. of Tai'an, Shandong.

### EXAMPLE 1: A SEEDLING SUBSTRATE USING RESIDUES FROM POPULUS FORESTS AS RAW MATERIALS

A seedling substrate using residues from Populus forests as raw materials includes the following raw materials in percent by volume: 50% of Populus fallen leaf scraps, 25% of Populus dead branch scraps, 5% of chicken manures, 15% of garden soil, and 5% of perlite; EM bacterial powder accounting for 0.1% of a mass of the raw materials; and 2 kg of controlled-release fertilizers mixed into each 1 m³ of seedling substrate.

A preparation method for a seedling substrate using residues from Populus forests as raw materials includes the following steps.

In step (1), raw materials for the production of a seedling substrate were prepared according to the above proportion.

In step (2), dead branches and fallen leaves from Populus forests were collected into bags after sorting and removing debris when forests were cleared for fire-prevention around the beginning of winter every year; the fallen leaves were crushed by a toothed claw pulverizer and a hammer pulverizer sequentially, and the dead branches were crushed by a slicing pulverizer and the hammer pulverizer sequentially, both being crushed to a particle size of 5-8 mm; and fallen leaf scraps and dead branch scraps were mixed in a volume ratio of 2:1 for later use.

In step (3), chicken manures, garden soil and EM bacteria were mixed with a mixture prepared in step (2) for large-heap fermentation or strip-stack fermentation at 60° C. for 49 days, and turning was performed once every 7 days; in the third turning process, perlite was added in a desired proportion; and a fermentation mixture with stable properties was obtained when a water content reached 30%, that is, the seedling substrate was obtained.

In step (4), 2 kg of controlled-release fertilizers were added to each 1 m³ of the fermentation mixture, followed by mixing thoroughly to obtain a finished product.

### EXAMPLE 2: A SEEDLING SUBSTRATE USING RESIDUES FROM POPULUS FORESTS AS RAW MATERIALS

A seedling substrate using residues from Populus forests as raw materials includes the following raw materials in percent by volume: 60% of Populus fallen leaf scraps, 20% of Populus dead branch scraps, 10% of chicken manures, 5% of garden soil, and 5% of perlite; EM bacterial powder accounting for 0.1% of a mass of mixed substrates; and 2 kg of controlled-release fertilizers mixed into each 1 m³ of seedling substrate.

A preparation method for a seedling substrate using residues from Populus forests as raw materials includes the following steps.

In step (1), raw materials for the production of a seedling substrate were prepared according to the above proportion.

In step (2), dead branches and fallen leaves from Populus forests were collected into bags after sorting and removing debris when forests were cleared for fire-prevention around the beginning of winter every year; the fallen leaves were crushed by a toothed claw pulverizer and a hammer pulverizer sequentially, and the dead branches were crushed by a slicing pulverizer and the hammer pulverizer sequentially, both being crushed to a particle size of 5-8 mm; and fallen leaf scraps and dead branch scraps were mixed in a volume ratio of 3:1 for later use.

In step (3), chicken manures, garden soil and EM bacteria were mixed with a mixture prepared in step (2) for large-heap fermentation or strip-stack fermentation at 65° C. for 50 days, and turning was performed once every 5 days; in the third turning process, perlite was added in a desired proportion; and a fermentation mixture with stable properties was obtained when a water content reached 30%, that is, the seedling substrate was obtained.

In step (4), 2 kg of controlled-release fertilizers were added to each 1 m³ of the fermentation mixture, followed by mixing thoroughly to obtain a finished product.

### EXAMPLE 3: A SEEDLING SUBSTRATE USING RESIDUES FROM POPULUS FORESTS AS RAW MATERIALS

A seedling substrate using residues from Populus forests as raw materials includes the following raw materials in percent by volume: 40% of Populus fallen leaf scraps, 30% of Populus dead branch scraps, 15% of chicken manures, 10% of garden soil, and 5% of perlite; EM bacterial powder accounting for 0.05% of a mass of a mixed substrate; and 2 kg of controlled-release fertilizers mixed into each 1 m³ of seedling substrate.

A preparation method for a seedling substrate using residues from Populus forests as raw materials includes the following steps.

In step (1), raw materials for the production of a seedling substrate were prepared according to the above proportion.

In step (2), dead branches and fallen leaves from Populus forests were collected into bags after sorting and removing debris when forests were cleared for fire-prevention around the beginning of winter every year; the fallen leaves were crushed by a toothed claw pulverizer and a hammer pulverizer sequentially, and the dead branches were crushed by a slicing pulverizer and the hammer pulverizer sequentially, both being crushed to a particle size of 5-8 mm; and fallen leaf scraps and dead branch scraps were mixed in a volume ratio of 4:3 for later use.

In step (3), chicken manures, garden soil and EM bacteria were mixed with a mixture prepared in step (2) for large-heap fermentation or strip-stack fermentation at 65° C. for 42 days, and turning was performed once every 7 days; in the third turning process, perlite was added in a desired proportion; and a fermentation mixture with stable properties was obtained when a water content reached 25-30%, that is, the seedling substrate was obtained.

In step (4), 2 kg of controlled-release fertilizers were added to each 1 m³ of the fermentation mixture, followed by mixing thoroughly to obtain a finished product.

### EXAMPLE 4: A SEEDLING SUBSTRATE USING RESIDUES FROM POPULUS FORESTS AS RAW MATERIALS

A seedling substrate using residues from Populus forests as raw materials includes the following mixed substrates in percent by volume: 60% of Populus fallen leaf scraps, 10% of Populus dead branch scraps, 10% of chicken manures, 10% of garden soil, and 10% of perlite; EM bacterial powder accounting for 0.1% of a mass of the mixed substrates; and 2 kg of controlled-release fertilizers mixed into each 1 m³ of seedling substrate.

A preparation method for a seedling substrate using residues from Populus forests as raw materials includes the following steps.

In step (1), raw materials for the production of a seedling substrate were prepared according to the above proportion.

In step (2), dead branches and fallen leaves from Populus forests were collected into bags after sorting and removing debris when forests were cleared for fire-prevention around the beginning of winter every year; the fallen leaves were crushed by a toothed claw pulverizer and a hammer pulverizer sequentially, and the dead branches were crushed by a slicing pulverizer and the hammer pulverizer sequentially, both being crushed to a particle size of 5-8 mm; and fallen leaf scraps and dead branch scraps were mixed in a volume ratio of 6:1 for later use.

In step (3), chicken manures, garden soil and EM bacteria were mixed with a mixture prepared in step (2) for large-heap fermentation or strip-stack fermentation at 60° C. for 48 days, and turning was performed once every 6 days; in the third turning process, perlite was added in a desired proportion; and a fermentation mixture with stable properties was obtained when a water content reached 30%, that is, the seedling substrate was obtained.

In step (4), 2 kg of controlled-release fertilizers were added to each 1 m³ of the fermentation mixture, followed by mixing thoroughly to obtain a finished product.

### EXAMPLE 5: A SEEDLING SUBSTRATE USING RESIDUES FROM POPULUS FORESTS AS RAW MATERIALS

A seedling substrate using residues from Populus forests as raw materials includes the following mixed substrates in percent by volume: 50% of Populus fallen leaf scraps, 30% of Populus dead branch scraps, 10% of chicken manures, 5% of garden soil, and 5% of perlite; EM bacterial powder accounting for 0.1% of a mass of the mixed substrates; and 2 kg of controlled-release fertilizers mixed into each 1 m³ of seedling substrate.

A preparation method for a seedling substrate using residues from Populus forests as raw materials includes the following steps.

In step (1), raw materials for the production of a seedling substrate were prepared according to the above proportion.

In step (2), dead branches and fallen leaves from Populus forests were collected into bags after sorting and removing debris when forests were cleared for fire-prevention around the beginning of winter every year; the fallen leaves were crushed by a toothed claw pulverizer and a hammer pulverizer sequentially, and the dead branches were crushed by a slicing pulverizer and the hammer pulverizer sequentially, both being crushed to a particle size of 5-8 mm; and fallen leaf scraps and dead branch scraps were mixed in a volume ratio of 5:3 for later use.

In step (3), chicken manures, garden soil and EM bacteria were mixed with a mixture prepared in step (2) for large-heap fermentation or strip-stack fermentation at 65° C. for 49 days, and turning was performed once every 7 days; in the third turning process, perlite was added in a desired proportion; and a fermentation mixture with stable properties was obtained when a water content reached 30%, that is, the seedling substrate was obtained.

In step (4), 2 kg of controlled-release fertilizers were added to each 1 m³ of the fermentation mixture, followed by mixing thoroughly to obtain a finished product.

### Use Conditions

A substrate 1, a substrate 2, a substrate 3, a substrate 4, and a substrate 5 are prepared according to Examples 1-5, respectively. Peat: perlite=1:1 was used as control 1 (denoted by CK1); peat: vermiculite=1:1 was used as control 2 (denoted by CK2); and peat: perlite: vermiculite=1:1:1 was used as control 3 (denoted by CK3).

The various physicochemical parameters of seedling substrates of Examples 1-5 and the conventional seedling substrates CK1, CK2 and CK3 are shown in Table 1.

TABLE 1
Determination of physicochemical properties of seedling substrate formulations with different proportions

| | Volume ratios of | | Electrical | | Maximum | |
|---|---|---|---|---|---|---|
| Serial | substrate raw | | conductivity | Volume-weight | water-holding | Porosity |
| number | materials | pH | (EC) (μs/cm) | (kg/m³) | capacity | (%) |
| 1 | CK1 | 6.22 ± 0.079 | 25.513 ± 6.034 | 0.11 ± 0.01 | 4.635 ± 0.071 | 0.511 ± 0.041 |
| | peat:perlite = 1:1 | | | | | |
| 2 | CK2 | 6.163 ± 0.059 | 22.3 ± 3.40 | 0.374 ± 0.029 | 1.434 ± 0.053 | 0.536 ± 0.022 |
| | peat:vermiculite = 1:1 | | | | | |
| 3 | CK3 | 6.3 ± 0.01 | 22.7 ± 2.364 | 0.346 ± 0.052 | 1.649 ± 0.243 | 0.563 ± 0.006 |
| | peat:perlite:vermic- | | | | | |
| | ulite = 1:1:1 | | | | | |
| 4 | Substrate 1 | 6.017 ± 0.081 | 18.873 ± 1.144 | 0.114 ± 0.011 | 5.188 ± 0.185 | 0.588 ± 0.033 |
| 5 | Substrate 2 | 6.187 ± 0.119 | 18.69 ± 0.735 | 0.12 ± 0.006 | 4.756 ± 0.122 | 0.571 ± 0.015 |
| 6 | Substrate 3 | 5.813 ± 0.006 | 13.087 ± 0.69 | 0.111 ± 0.013 | 4.548 ± 0.313 | 0.502 ± 0.045 |
| 7 | Substrate 4 | 6.343 ± 0.021 | 13.593 ± 0.625 | 0.108 ± 0.001 | 5.162 ± 0.13 | 0.555 ± 0.014 |
| 8 | Substrate 5 | 5.91 ± 0.23 | 16.793 ± 1.025 | 0.112 ± 0.011 | 4.985 ± 0.33 | 0.557 ± 0.016 |

As can be seen from Table 1, the physicochemical properties of the seedling substrates of Examples 1-5 are all within an ideal range. The substrates, as sowing seedling substrates, can play a role in replacing or reducing peat, but as cutting substrates, due to larger maximum water-holding capacities, the moisture management is to be strengthened. Compared with peat, perlite, vermiculite and other raw materials, the dead branches and fallen leaves have the advantages of wide sources, low prices and renewability. A production cost of preparation of the seedling substrates of Examples 1-5 is about 50% of that of conventional seedling substrates, and the recycling of agricultural and forestry residues can be initially formed, which is of greater help to reduce costs and increase efficiency in seedling production.

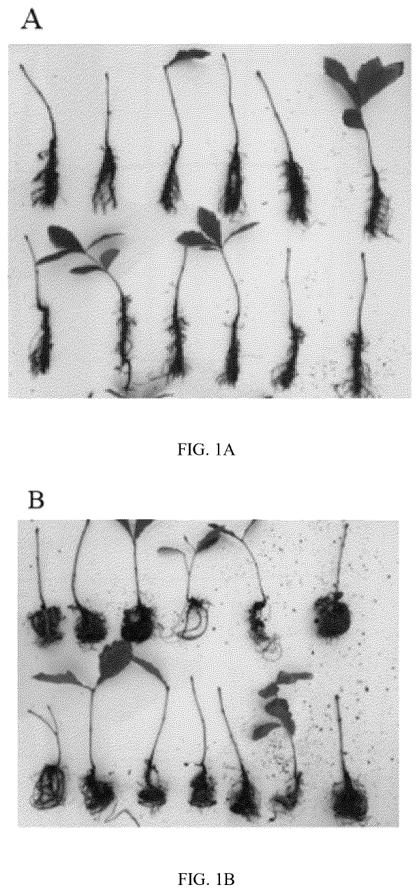

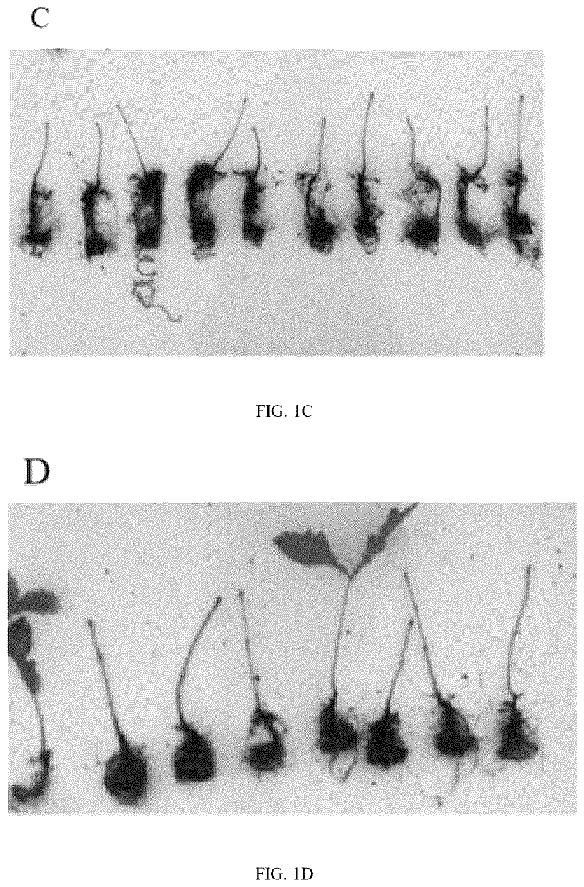

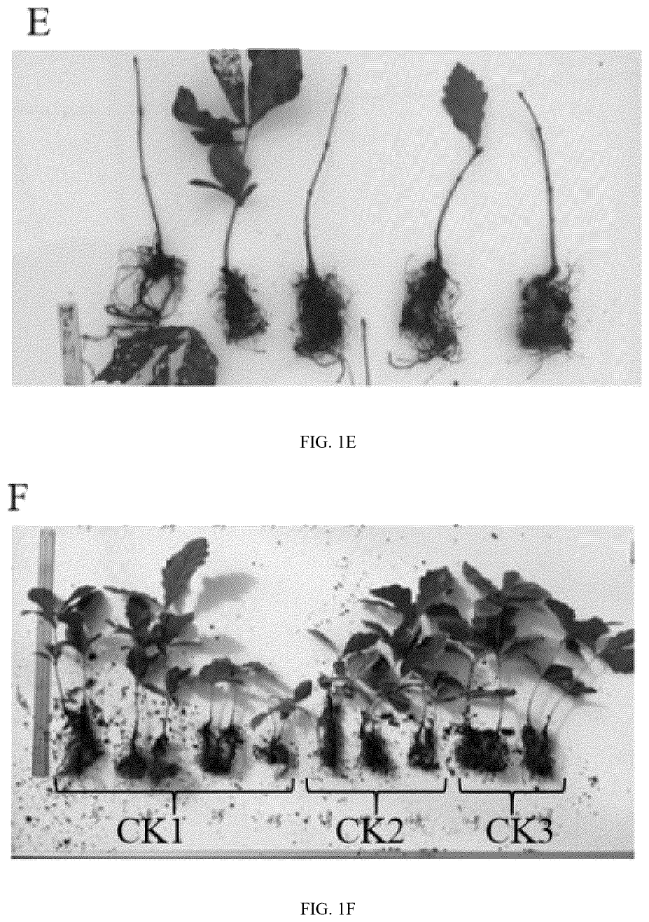

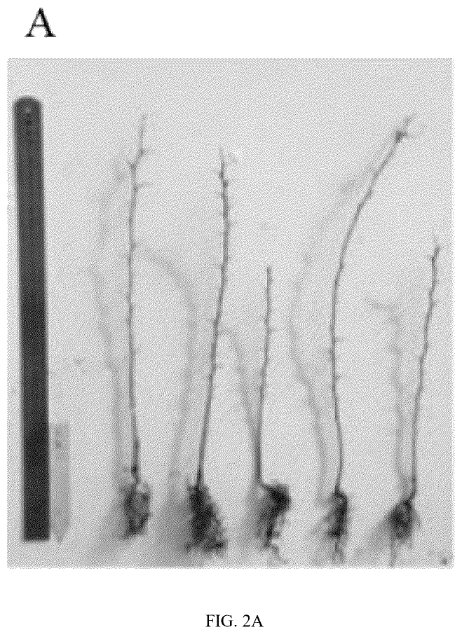

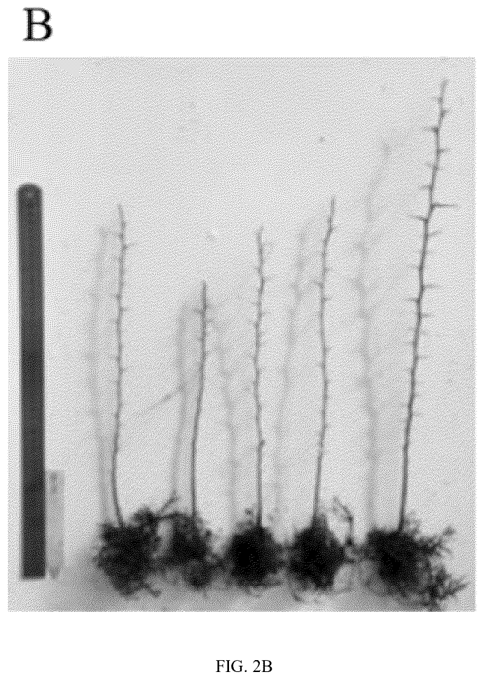

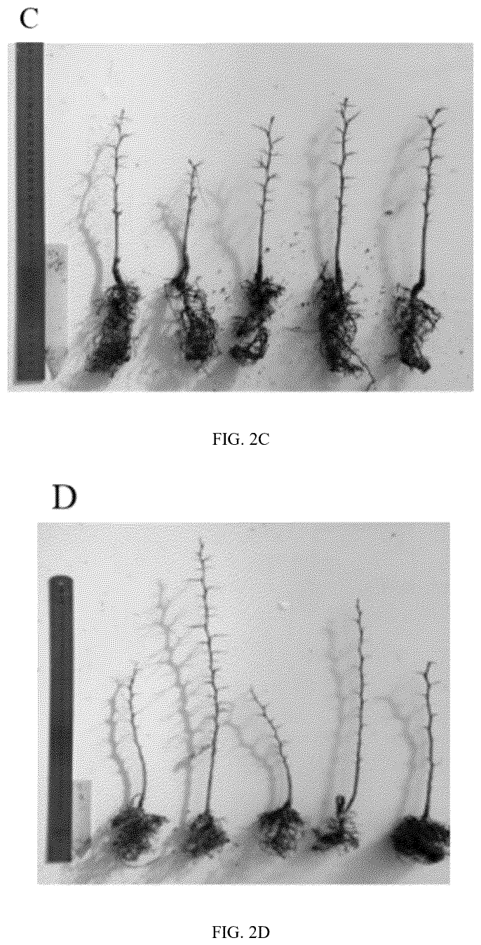

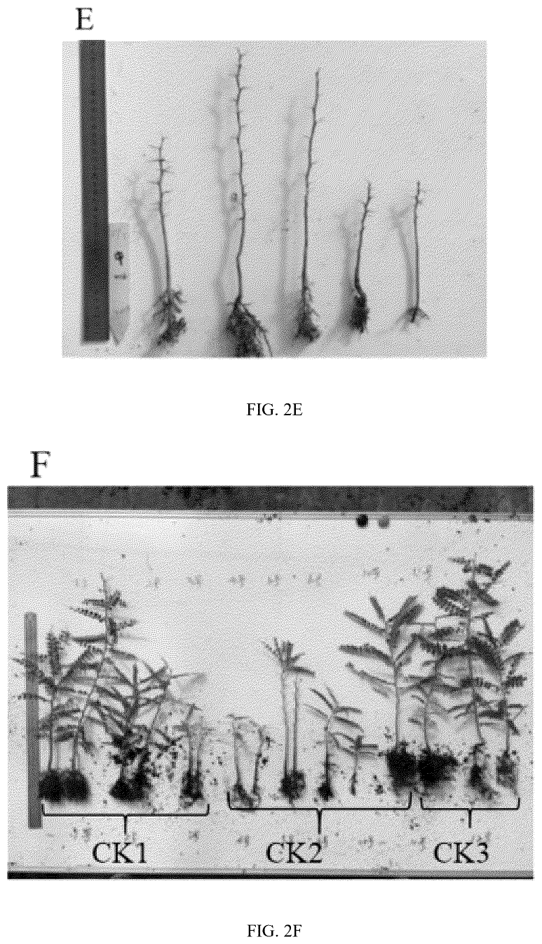

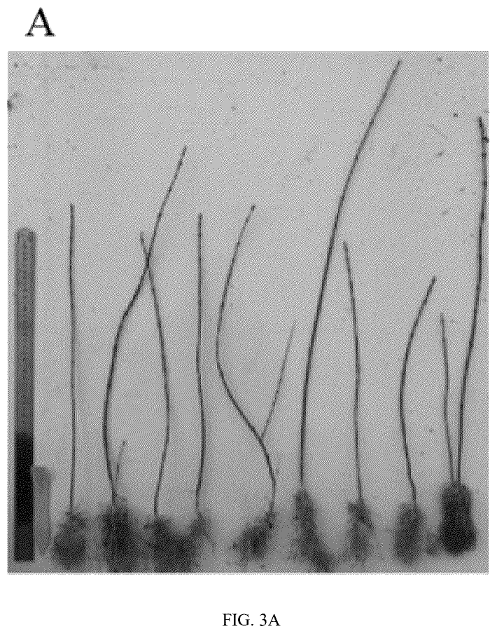

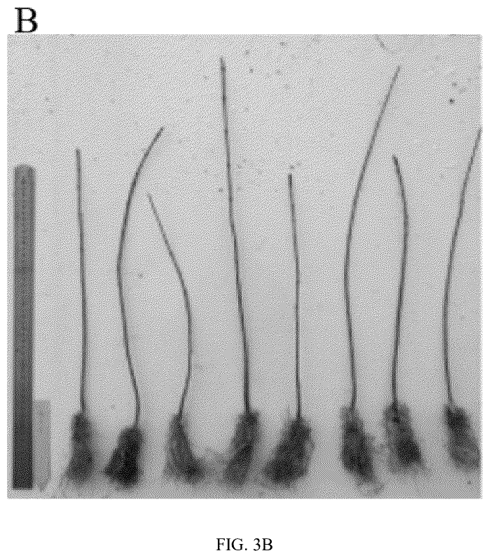

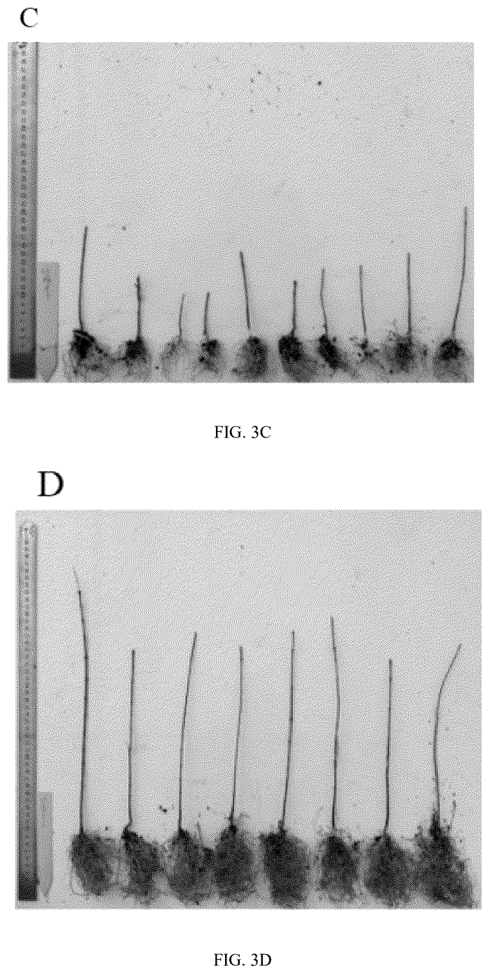

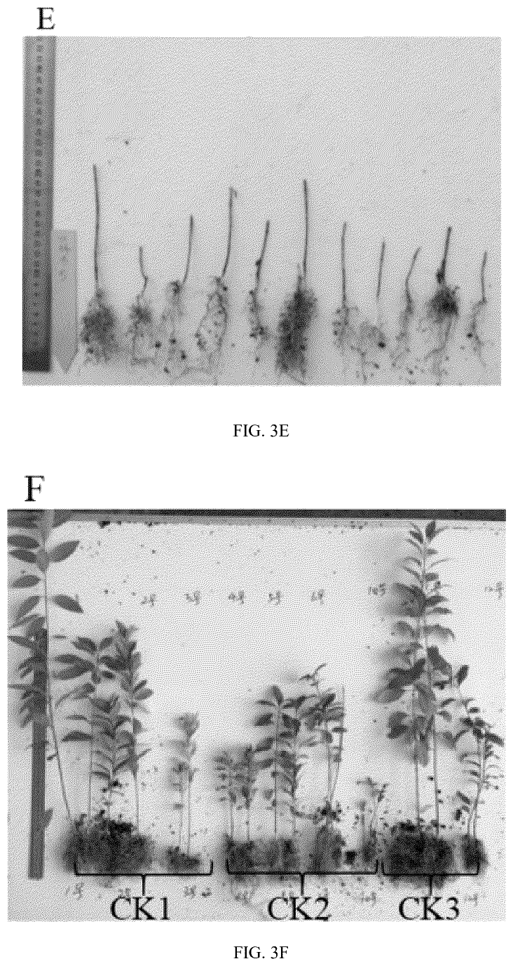

Growth indicators (except for the different substrates, other cultivation conditions are identical) are compared as shown in Table 2 and FIGS. 1-3.

TABLE 2
Seedling growth rhythms of three tree species with different substrate proportions

| | | Jun. 29, 2022 | | Aug. 13, 2022 | | Sep. 24, 2022 | | Nov. 24, 2022 | |
|---|---|---|---|---|---|---|---|---|---|
| Tree | | Seedling | Ground | Seedling | Ground | Seedling | Ground | Seedling | Ground |
| species | Process | height/cm | diameter/mm | height/cm | diameter/mm | height/cm | diameter/mm | height/cm | diameter/mm |
| Quercus | CK1 | 12.0 ± 4.0 | 1.62 ± 0.46 | 12.7 ± 4.0 | 1.95 ± 0.68 | 12.8 ± 4.1 | 1.97 ± 0.66 | 13.6 ± 3.3 | 3.37 ± 0.75 |
| mongolica | CK2 | 14.5 ± 4.7 | 2.12 ± 0.49 | 16.5 ± 4.7 | 2.54 ± 0.72 | 16.7 ± 4.2 | 2.57 ± 0.73 | 16.8 ± 2.1 | 3.21 ± 0.74 |
| | CK3 | 12.4 ± 5.1 | 1.53 ± 0.58 | 15.5 ± 4.2 | 2.75 ± 0.89 | 16.0 ± 5.5 | 2.75 ± 0.60 | 16.4 ± 2.1 | 2.90 ± 0.29 |
| | Substrate | 15.8 ± 4.1 | 2.13 ± 0.53 | 16.4 ± 4.7 | 2.77 ± 0.84 | 20.7 ± 4.4 | 3.32 ± 0.77 | 20.9 ± 4.5 | 3.36 ± 0.90 |
| | 1 | | | | | | | | |
| | Substrate | 13.9 ± 4.8 | 1.84 ± 0.60 | 17.0 ± 4.8 | 2.70 ± 0.83 | 18.3 ± 6.3 | 2.67 ± 0.76 | 18.6 ± 4.8 | 3.59 ± 0.74 |
| | 2 | | | | | | | | |
| | Substrate | 11.8 ± 2.2 | 1.33 ± 0.23 | 11.9 ± 2.0 | 2.51 ± 0.23 | 12.3 ± 2.2 | 2.47 ± 0.24 | 12.4 ± 1.8 | 2.99 ± 0.44 |
| | 3 | | | | | | | | |
| | Substrate | 10.6 ± 2.3 | 1.45 ± 0.32 | 12.1 ± 2.0 | 2.66 ± 0.40 | 12.6 ± 2.6 | 2.56 ± 0.33 | 12.5 ± 1.4 | 2.66 ± 0.41 |
| | 4 | | | | | | | | |
| | Substrate | 11.2 ± 2.3 | 1.67 ± 0.28 | 11.7 ± 3.1 | 2.74 ± 0.39 | 12.2 ± 2.5 | 2.79 ± 0.39 | 12.9 ± 1.6 | 2.91 ± 0.41 |
| | 5 | | | | | | | | |
| Gleditsia | CK1 | 22.1 ± 5.0 | 3.58 ± 0.54 | 24.8 ± 8.1 | 3.60 ± 0.82 | 32.2 ± 8.7 | 3.70 ± 0.93 | 32.6 ± 8.7 | 3.97 ± 0.67 |
| sinensis | CK2 | 25.0 ± 9.3 | 3.05 ± 0.62 | 27.9 ± 8.7 | 3.40 ± 0.77 | 28.9 ± 7.2 | 4.06 ± 0.74 | 32.2 ± 7.3 | 4.40 ± 0.68 |
| | CK3 | 10.4 ± 2.8 | 2.80 ± 0.41 | 10.8 ± 3.2 | 2.89 ± 0.65 | 10.8 ± 3.0 | 3.17 ± 0.75 | 15.1 ± 2.9 | 3.40 ± 0.84 |
| | Substrate | 30.3 ± 12.6 | 2.56 ± 0.65 | 42.0 ± 9.3 | 3.34 ± 0.66 | 40.1 ± 13.0 | 3.62 ± 0.59 | 42.7 ± 6.1 | 4.09 ± 0.91 |
| | 1 | | | | | | | | |
| | Substrate | 29.7 ± 11.6 | 2.6 ± 0.7 | 42.0 ± 9.3 | 3.3 ± 0.7 | 43.1 ± 12.0 | 3.6 ± 0.6 | 43.8 ± 10.7 | 3.7 ± 0.8 |
| | 2 | | | | | | | | |
| | Substrate | 22.3 ± 6.7 | 2.95 ± 0.46 | 25.3 ± 8.5 | 3.54 ± 0.67 | 25.5 ± 9.7 | 3.67 ± 0.70 | 27.3 ± 4.8 | 4.41 ± 1.54 |
| | 3 | | | | | | | | |
| | Substrate | 15.7 ± 4.5 | 2.88 ± 0.60 | 16.8 ± 4.1 | 3.01 ± 0.54 | 16.3 ± 4.2 | 3.34 ± 0.70 | 15.2 ± 1.9 | 3.25 ± 0.62 |
| | 4 | | | | | | | | |
| | Substrate | 15.1 ± 5.2 | 3.10 ± 0.73 | 15.0 ± 4.6 | 3.19 ± 0.73 | 15.4 ± 5.2 | 3.29 ± 0.73 | 16.5 ± 5.4 | 3.73 ± 0.59 |
| | 5 | | | | | | | | |
| Euonymus | CK1 | 15.8 ± 7.3 | 1.62 ± 0.41 | 29.9 ± 12.3 | 2.30 ± 0.77 | 30.4 ± 12.2 | 2.50 ± 0.83 | 32.2 ± 10.0 | 2.83 ± 0.94 |
| maackii | CK2 | 15.1 ± 5.4 | 1.67 ± 0.38 | 25.4 ± 9.1 | 2.15 ± 0.51 | 30.2 ± 7.2 | 2.29 ± 0.33 | 31.4 ± 7.9 | 2.44 ± 0.60 |
| | CK3 | 15.2 ± 7.8 | 1.61 ± 0.39 | 24.9 ± 10.1 | 2.33 ± 0.78 | 29.6 ± 16.2 | 2.45 ± 0.74 | 34.1 ± 8.5 | 2.46 ± 0.82 |
| | Substrate | 29.2 ± 9.1 | 2.13 ± 0.46 | 42.8 ± 12.7 | 3.01 ± 0.74 | 43.3 ± 12.1 | 3.07 ± 0.72 | 43.7 ± 5.4 | 3.86 ± 0.75 |
| | 1 | | | | | | | | |
| | Substrate | 20.7 ± 10.7 | 1.54 ± 0.37 | 38.0 ± 12.5 | 2.31 ± 0.60 | 39.0 ± 11.3 | 3.12 ± 0.76 | 45.1 ± 8.7 | 3.20 ± 0.65 |
| | 2 | | | | | | | | |
| | Substrate | 6.1 ± 2.9 | 1.15 ± 0.28 | 6.6 ± 4.7 | 1.22 ± 0.41 | 7.4 ± 5.8 | 1.26 ± 0.48 | 7.8 ± 3.6 | 1.27 ± 0.30 |
| | 3 | | | | | | | | |
| | Substrate | 5.3 ± 1.9 | 1.16 ± 0.26 | 6.9 ± 3.4 | 1.20 ± 0.30 | 7.2 ± 3.5 | 1.23 ± 0.33 | 7.7 ± 4.8 | 1.27 ± 0.30 |
| | 4 | | | | | | | | |
| | Substrate | 7.0 ± 3.2 | 1.39 ± 0.36 | 8.3 ± 4.5 | 1.48 ± 0.44 | 8.4 ± 5.0 | 1.51 ± 0.50 | 9.1 ± 3.3 | 1.63 ± 0.54 |
| | 5 | | | | | | | | |

As can be seen from Table 2, in the production of seedlings of three species of Quercus mongolica, Gleditsia sinensis and Euonymus maackii, the growth of seedlings cultivated by the substrate 1 and the substrate 2 is superior to that of seedlings cultivated by the 3 groups of conventional seedling substrates, and the seedling height and ground diameter are better than those of the control group in the same period. Taking Quercus mongolica as an example, according to the final survey statistics, the order of seedling height is substrate 1>substrate 2>CK2>CK3>CK1>substrate 5>substrate 4>substrate 3,in which an average seedling height of substrate 1 is 20.9 cm, 7.3 cm higher than the 13.6 cm of CK1; the order of the ground diameter is substrate 2>CK1>substrate 1>CK2>substrate 3>substrate 5>CK3>substrate 4, with little difference, in which an average ground diameter of substrate 2 is 3.59 mm, 0.22 mm thicker than the 3.37 mm of CK1, and 0.93 mm thicker than that of substrate 4.

Although preferred examples of the present disclosure have been described, those examples can be subjected to additional changes and modifications once the basic creative concepts are known to those skilled in the art. Accordingly, the attached claims are intended to be interpreted to include the preferred examples as well as all variations and modifications falling within the scope of the present disclosure.

It is apparent that those skilled in the art can make various variations and modifications to the present disclosure without departing from the spirit and scope of the present disclosure. Accordingly, the present disclosure is intended to include such modifications and variations provided that they fall within the scope of the claims of the present disclosure and equivalents thereof.

1. A preparation method for a seedling substrate using residues from Populus forests as raw materials, comprising the following steps:
crushing Populus fallen leaves into Populus fallen leaf scraps; and crushing Populus dead branches into Populus dead branch scraps; and
mixing the Populus fallen leaf scraps, the Populus dead branch scraps, chicken manures and garden soil to obtain a mixture; adding effective microorganisms (EM) bacterial powder to the mixture for fermentation; and adding perlite during the fermentation to obtain a seedling substrate.

2. The preparation method according to claim 1, wherein the Populus fallen leaf scraps, the Populus dead branch scraps, the chicken manures, the garden soil and the perlite are mixed in volume percentages of 40%-60%, 10%-30%, 5%-15%, 5%-15%, and 5%-10% in a total of 100%,
the Populus fallen leaf scraps and the Populus dead branch scraps having a particle size of 5-8 mm.

3. The preparation method according to claim 1, wherein a mass of the EM bacterial powder is 0.05-0.1% of a mass of the mixture.

4. The preparation method according to claim 1, wherein the fermentation is large-heap fermentation or strip-stack fermentation.

5. The preparation method according to claim 4, wherein heap-turning and stack-transferring are performed every 5-7 days during the fermentation.

6. The preparation method according to claim 1, wherein the fermentation is performed at 60-65° C. for 40-50 days.

7. The preparation method according to claim 1, wherein a water content of the seedling substrate is 25-30%.

8. The preparation method according to claim 1, wherein the seedling substrate is further mixed with controlled-release fertilizers, 1 m³ of the seedling substrate being mixed with 1-3 kg of the controlled-release fertilizers.

9. A seedling substrate prepared by a preparation method according to claim 1.

10. An application of a seedling substrate according to claim 9 in forest seedling cultivation.
